(19) United States
(12) Patent Application Publication
(10) Pub. No.: US 2015/0013524 A1
(43) Pub. Date: Jan. 15, 2015

(54) POP-UP APPARATUS

(71) Applicant: Michael Prichard, Carlisle, MA (US)

(72) Inventor: Michael Prichard, Carlisle, MA (US)

(73) Assignee: MISELU INC., San Francisco, CA (US)

(21) Appl. No.: 14/326,411

(22) Filed: Jul. 8, 2014

Related U.S. Application Data
(60) Provisional application No. 61/844,325, filed on Jul. 9, 2013.

(51) Int. Cl. G10C 3/12

(52) U.S. Cl. CPC G10C 3/12
USPC 84/423 R

(57) ABSTRACT

Embodiments generally relate to music devices. In one embodiment, an apparatus includes a first four-bar mechanism operably connected to a first user interface. The apparatus also includes a second four-bar mechanism operably connected to a second user interface. The apparatus also includes a third four-bar mechanism operably connected to the first and second four-bar mechanisms.

### CROSS REFERENCE TO RELATED APPLICATIONS

This application claims priority from U.S. Provisional Patent Application No. 61/844,325, entitled “Pop-Up Apparatus,” filed Jul. 9, 2013, which is hereby incorporated by reference as if set forth in full in this application for all purposes.

### BACKGROUND

Full-size musical instrument devices such as keyboards are sometimes reduced in size for reasons including space, weight, or portability. Currently available compact musical devices attempt to strike a compromise between making significant reductions in size and weight, and providing an enjoyable playing experience.

### SUMMARY

Embodiments generally relate to music devices. In one embodiment, an apparatus includes a first four-bar mechanism operably connected to a first user interface. The apparatus also includes a second four-bar mechanism operably connected to a second user interface. The apparatus also includes a third four-bar mechanism operably connected to the first and second four-bar mechanisms.

### BRIEF DESCRIPTION OF THE DRAWINGS

FIG. 1 is a schematic side view showing a pop-up apparatus in an open state, according to some embodiments.

FIG. 2 is a schematic side view showing a pop-up apparatus in a more closed state than in FIG. 1, according to some embodiments.

FIG. 3 is a schematic side view showing an example portion of a pop-up assembly implemented as a keyboard apparatus in an open state, according to some embodiments.

FIG. 4 is a schematic side view showing an example portion of a pop-up assembly implemented as a keyboard apparatus in closed state, according to some embodiments.

FIG. 5 is a schematic top view of an example pop-up assembly implemented as a keyboard apparatus in a closed state, according to some embodiments.

FIG. 6 is a schematic perspective view of an example pop-up assembly implemented as a keyboard apparatus in an open state, according to some embodiments.

FIG. 7 is a schematic perspective view of an example pop-up assembly implemented as a keyboard apparatus in an open state, according to some embodiments.

FIG. 8 illustrates an example simplified flow diagram for providing a pop-up apparatus, according to some embodiments.

### DETAILED DESCRIPTION

Embodiments described herein enable a user to enjoy a music playing experience that is relatively close to that of playing a standard size musical instrument. Embodiments provide a music device that is not only of reduced size while in a playable configuration, but also readily reconfigurable into an extremely compact, “collapsed” form when being transported or stored.

In various embodiments, an apparatus includes a first four-bar mechanism (e.g., a four-bar parallelogram linkage), operably connected to a first user interface, where the first four-bar mechanism enables the first user interface to be positioned in a first plane. The apparatus also includes a second four-bar mechanism (e.g., another four-bar parallelogram linkage) operably connected to a second user interface, where the second four-bar mechanism enables the second user interface to be positioned in a second plane. The apparatus also includes a third four-bar mechanism (e.g., a four-bar convex quadrilateral linkage) operably connected to the first and second four-bar mechanisms, where the third four-bar mechanism synchronizes movement of the first and second four-bar mechanisms.

As described in more detail below, in various embodiments, the apparatus includes a base that functions as a common bar in each of the first, second, and third four-bar mechanisms. Also, the first and third four-bar mechanisms share two common bars, one of which is the base, and the second and third four-bar mechanisms share two common bars, one of which is also the base.

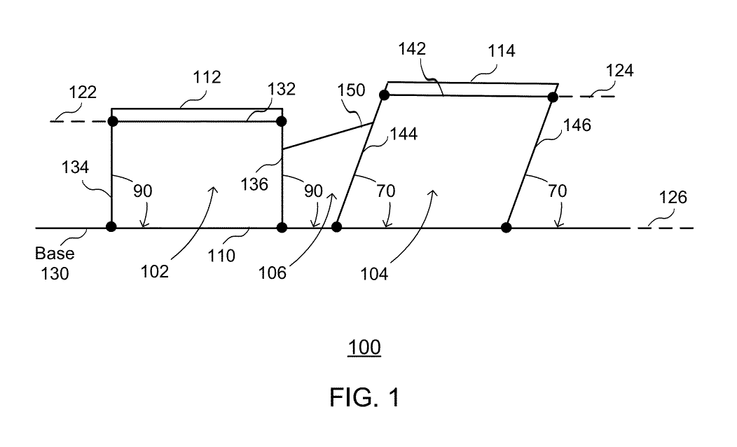

FIG. 1 is a schematic side view showing a pop-up apparatus 100 in an open state, according to some embodiments. As shown, in some embodiments, pop-up apparatus 100 includes three four-bar-mechanisms 102, 104, and 106. As shown, two of the four-bar-mechanisms 102 and 104 are four-bar parallelogram linkages, and one of the four-bar-mechanisms 106 is a four-bar convex quadrilateral linkage.

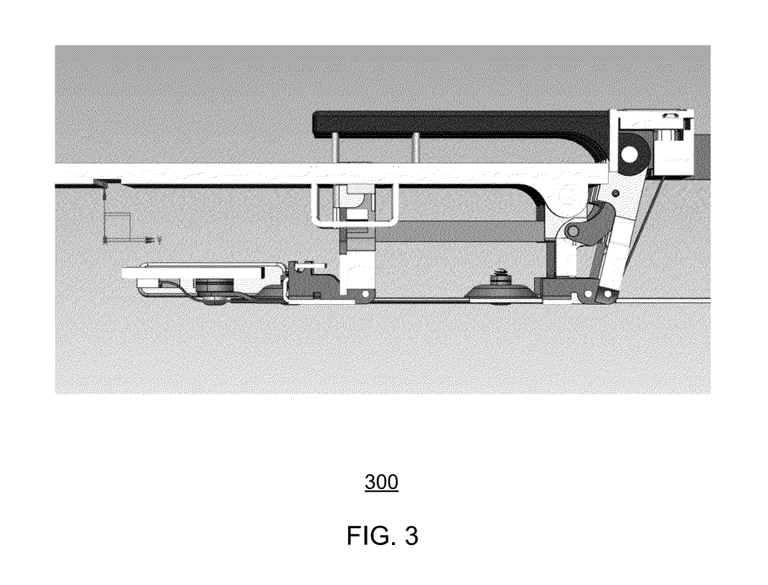

In various embodiments, four-bar mechanism 102 is operably connected to a user interface 112, where four-bar mechanism 102 enables user interface 112 to be positioned in a plane 122. In various implementations, user interface 112 may represent white keys of a piano keyboard (e.g., the white keys shown in FIG. 3). Furthermore, in various embodiments, four-bar mechanism 104 is operably connected to a user interface 114, where four-bar mechanism 104 enables user interface 114 to be positioned in a plane 124. In various implementations, user interface 112 may represent black keys of a piano keyboard (e.g., the black keys shown in FIG. 3). As shown, plane 122 is different from plane 124, and both planes 122 and 124 are different from a base plane 126, which is the plane of base 130. Also, planes 122, 124, and 126 are parallel to each other. As such user interface 112, user interface 114, and base 130 are parallel to each other.

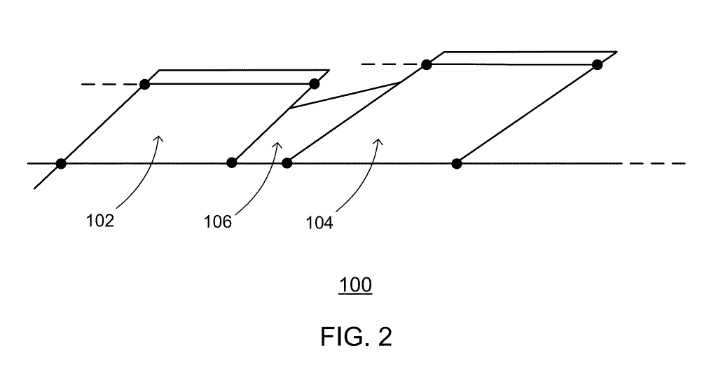

Furthermore, in various embodiments, four-bar mechanism 106 is operably connected to four-bar mechanisms 102 and 104. As described in more detail below in connection with FIG. 2, four-bar mechanism 106 synchronizes movement of four-bar mechanisms 102 and 104.

In various embodiments, pop-up apparatus 100 includes a base 130 that not only functions a support base for pop-up apparatus 100 but also functions as a common bar in each of four-bar mechanism 102, four-bar mechanism 104, and four-bar mechanism 106. As such, base 130 may also be referred to as base bar 130, or bar 130.

Four-bar mechanism 102 includes base bar 130, bar 132, bar 134, and bar 136. As shown, bar 132 is parallel to base bar 130, and bars 134 and 136 are parallel to each other. Four-bar mechanism 104 includes base bar 130, bar 142, bar 144, and bar 146. As shown, bar 142 is parallel to base bar 130, and bars 144 and 146 are parallel to each other. Four-bar mechanism 106 includes base bar 130, bar 136, bar 144, and a bar 150.

As shown, four-bar mechanisms 102 and 106 share two common bars—base bar 130 and bar 136. Four-bar mechanisms 104 and 106 share two common bars—base bar 130 and bar 144. As indicated above, all three four-bar mechanisms 102, 104, and 106 share base bar 130.

In various embodiments, the respective four bars of each of four-bar mechanisms 102, 104, and 106 are connected in a loop by four joints or pivot points (shown as solid circles). The bars may also be referred to as links. In various embodiments, the joints of each of four-bar mechanisms 102, 104, and 106 are configured to move all links relative to base bar 130, such that four-bar mechanisms 102, 104, and 106 function as rocker four-bar linkages. In other words bars 134, 136, 144, and 146 rotate around their respective joints that connect to base bar 130. As described in more detail below, the joints of four-bar mechanisms 102 and 106 are configured such that bars 132 and 142 move in parallel planes relative to base bar 130.

As described in more detail below, bar 150 of four-bar mechanism 106 connects bars 136 and 144. As such, bar 150 synchronizes movement of four-bar mechanisms 102 and 104, via bars 136 and 144.

In various embodiments, bar 132 lies substantially exactly in plane 122, and the bottom of user interface 112 lies substantially exactly in plane 122. The exact location of plane 122 relative to bar 132 and relative to the bottom of user interface 112 may vary, depending on the particular embodiment. Similarly, in various embodiments, bar 142 lies substantially exactly in plane 124, and the bottom of user interface 114 lies substantially exactly in plane 124. The exact location of plane 124 relative to bar 142 and relative to the bottom of user interface 114 may vary, depending on the particular embodiment.

As indicated above, FIG. 1 shows that pop-up apparatus 100 is in an open state, where user interfaces 112 and 114 are popped up, where user interface 112 is at a predetermined distance from base plane 126, and where user interface 114 is at a predetermined distance from base plane 126. The distance between user interface 112 and base plane 126 may vary depending on the particular implementation. Also, the distance between user interface 114 and base plane 126 may vary depending on the particular implementation.

FIG. 2 is a schematic side view showing pop-up apparatus 100 in a more closed state than in FIG. 1, according to some embodiments. FIGS. 1 and 2 both illustrate spatial relationships between four-bar mechanisms 102, 104, and 106, where FIG. 1 shows pop-up apparatus 100 in an open state, and FIG. 2 shows pop-up apparatus 100 in a more closed state.

As shown in FIG. 2, as pop-up apparatus 100 approaches a closed state, bars 132 and 142 approach base bar 130. Also, planes 122 and 124 approach base plane 126. Also, the angle between bar 134 and base bar 130 and the angle between bar 136 and base bar 130 approach 0 degrees during the transition from the open state to the closed state. In some embodiments, these angles are both 90 degrees in the open state. In the open state, these angles may be other than 90 degrees depending on the particular embodiment.

Similarly, the angle between bar 144 and base bar 130 and the angle between bar 146 and base bar 130 approach 0 degrees during the transition from the open state to the closed state. In some embodiments, these angles are both 70 degrees in the open state. In the open state, these angles may be other than 70 degrees depending on the particular embodiment.

In the closed state, bars 132 and 142 are in line with base bar 130. Also, planes 122 and 124 are in line with base plane 126. For ease of illustration, FIG. 2 shows pop-up apparatus 100 in a state that is more closed than the open state, yet not in a fully closed state. This enables the components of four-bar mechanisms 102, 104, and 106 to be more clearly illustrated during the transition from the open state to closed state.

As indicated above, four-bar mechanism 106 synchronizes movement of four-bar mechanisms 102 and 104. Referring to both FIGS. 1 and 2, bar 150 connects bars 136 and 144. Accordingly, bar 150 connects four-bar mechanisms 102 and 106. As a result, when four-bar mechanism 102 transitions from the open state to the closed state, four-bar mechanism 104 also transitions from the open state to the closed state.

For ease of illustration, some embodiments are described herein in the context of pop-up apparatus 100 transitioning from the open state to the closed state. These same embodiments also apply in the context of pop-up apparatus 100 transitioning from the closed state to the open state, yet in reverse.

In various embodiments, four-bar mechanism 106 enables four-bar mechanisms 102 and 104 to reach the open state at substantially the same time, and to reach the closed state at substantially the same time. In some embodiments, this is achieved by four-bar mechanism 106 causing four-bar mechanism 104 to transition from the open state to the closed state, and vice versa, faster than four-bar mechanism 102. In other words, in various embodiments, whether pop-up apparatus 100 is transitioning from the open to the closed state, or vice versa, bar 142 travels faster than bar 132.

In various implementations, the rate at which four-bar mechanism 104 transitions from the open state to the closed state compared to the rate at which four-bar mechanism 102 transitions from the open state to the closed state, and vice versa, is based on where the ends of bar 150 are connected to respective bars 136 and 144. As shown, the ends of bar 150 are connected in somewhere in the middle portions of respective bars 136 and 144. The particular connection points will depend on the particular embodiment. Furthermore, the particular position or slope of bar 150 relative to base bar 130 will depend on the particular embodiment. In various embodiments, a combination of one or more of the angles of four-bar mechanism 106, the connection point locations, and/or the slope of bar 150 relative to base bar 130 determine the relative rates at which four-bar mechanisms 102 and 104 transition from the open state to the closed state, and vice versa.

As indicated above, four-bar mechanisms 102 and 104 may each be operably connected to one or more user interfaces. As described in more detail below, such user interfaces may include, for example, black and white keys of a piano keyboard. In some embodiments, user interfaces may include sound controls (e.g., knobs, sliders, buttons, capacitive touch strips, etc.). In some embodiments, user interfaces may connect directly to four-bar mechanisms 102 and 104 or may couple to a given four-bar mechanism 102 or 104 via an intermediary element such as a rack, which couples to the given four-bar mechanism 102 or 104.

In some embodiments, a rack may be coupled to a four-bar mechanism such as four-bar mechanism 104, where the rack is configured to hold/support objects. In some embodiments, the rack may be configured to hold an object that is controlled or viewable by a user. For example, the rack may be configured to hold an object such a user interface device (e.g., a tablet computer). In various embodiments, base 120 of pop-up apparatus 100 may be configured to function as a protective cover for an electronic device when pop-up apparatus 100 is in a closed stated. The rack may be configured to hold other objects as well, such as sheet music.

As indicated above, four-bar mechanisms 102 and 104 may support various types of user interfaces, such as black and white keys of a piano keyboard. As described in more detail below, for example, four-bar mechanism 102 may support white keys of a piano keyboard, and four-bar mechanism 104 may support black keys of the piano keyboard.

FIG. 3 is a schematic side view showing an example portion of a pop-up assembly 300 implemented as a keyboard apparatus in an open state, according to some embodiments. As shown, a four-bar mechanism (e.g., four-bar mechanism 102 of FIG. 1) may support white keys of a piano keyboard, and a four-bar mechanism (e.g., four-bar mechanism 104 of FIG. 1) may support black keys of the piano keyboard. In various embodiments, any given four-bar mechanism may support multiple objects. For example, in some embodiments, four-bar mechanism 104 may support both black keys and a rack, which in turns may support one or more objects (e.g., a tablet computer).

In some embodiments, the angular rotations of four-bar mechanisms 102 and 104 may be 90 degrees for the white keys and 70 degrees for the black keys, respectively. Other degree amounts are possible, depending on the particular embodiment.

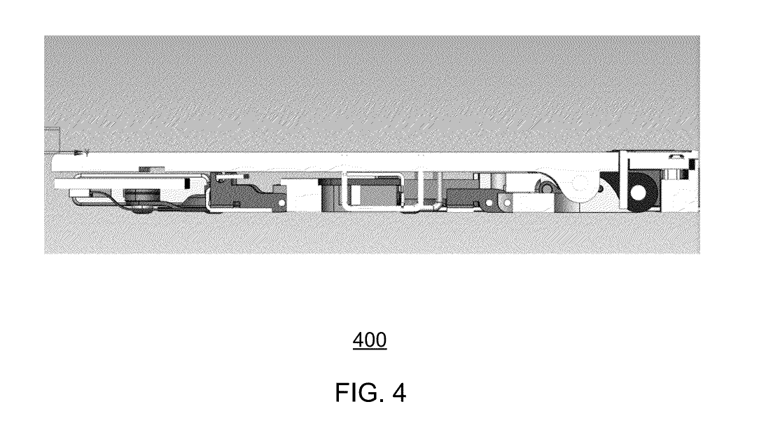

FIG. 4 is a schematic side view showing an example portion of a pop-up assembly 400 implemented as a keyboard apparatus in closed state, according to some embodiments. As shown, in a closed state, the four-bar mechanisms (e.g., four-bar mechanism 102 and 104 of FIG. 1) collapse such that the tops of the white and black keys are align/flush.

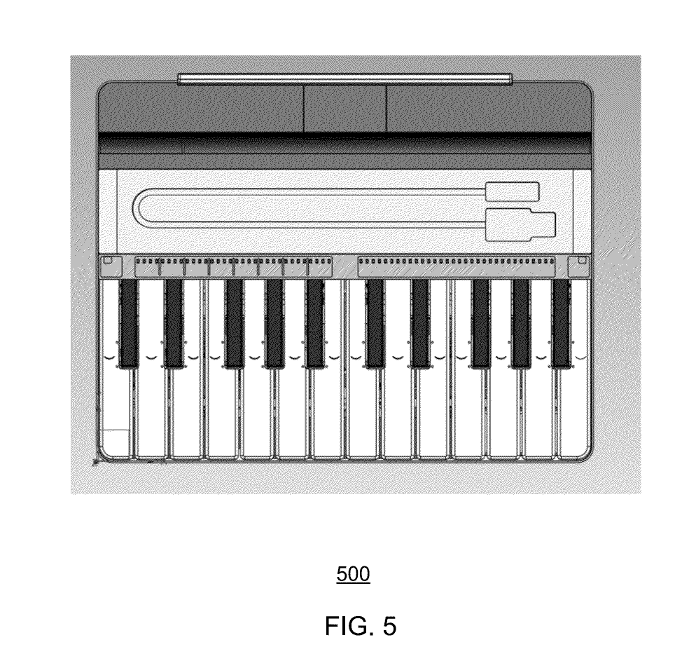

FIG. 5 is a schematic top view of an example pop-up assembly 500 implemented as a keyboard apparatus in a closed state, according to some embodiments. In various embodiments, each of the four-bar mechanisms 102 and 104 are configured to support multiple objects. For example, as shown, four-bar mechanism 102 may be configured to support multiple white keys, and four-bar mechanism 104 may be configured to support multiple black keys. Furthermore, four-bar mechanisms 102 and 104 may be configured to stagger the white keys and black keys as shown.

As indicated above, in various embodiments, four-bar mechanism 106 enables four-bar mechanisms 102 and 104 reach the open state at substantially the same time, and reach the closed state at substantially the same time. Furthermore, four-bar mechanisms 102 and 104 are positioned relative to each other such that the rear of the black keys and the rear of the white keys are in line in the open state, in the closed state, and during the transition between the open state and the closed state.

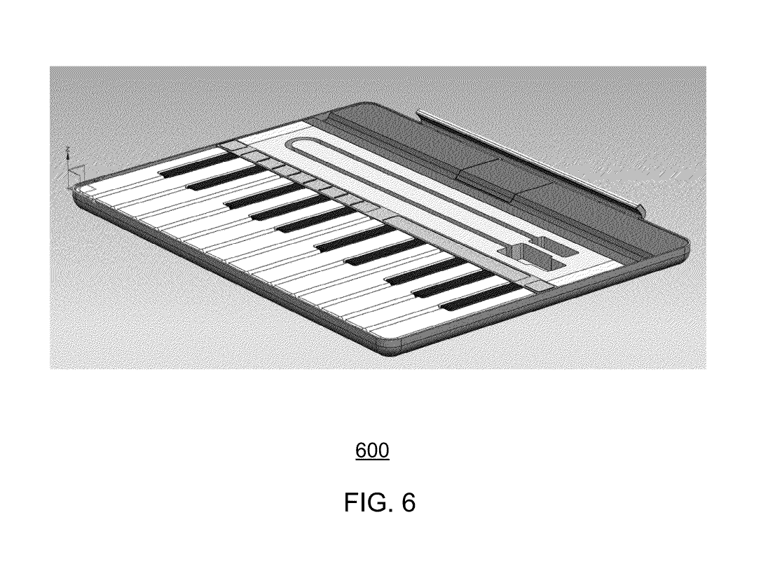

FIG. 6 is a schematic perspective view of an example pop-up assembly 600 implemented as a keyboard apparatus in an open state, according to some embodiments.

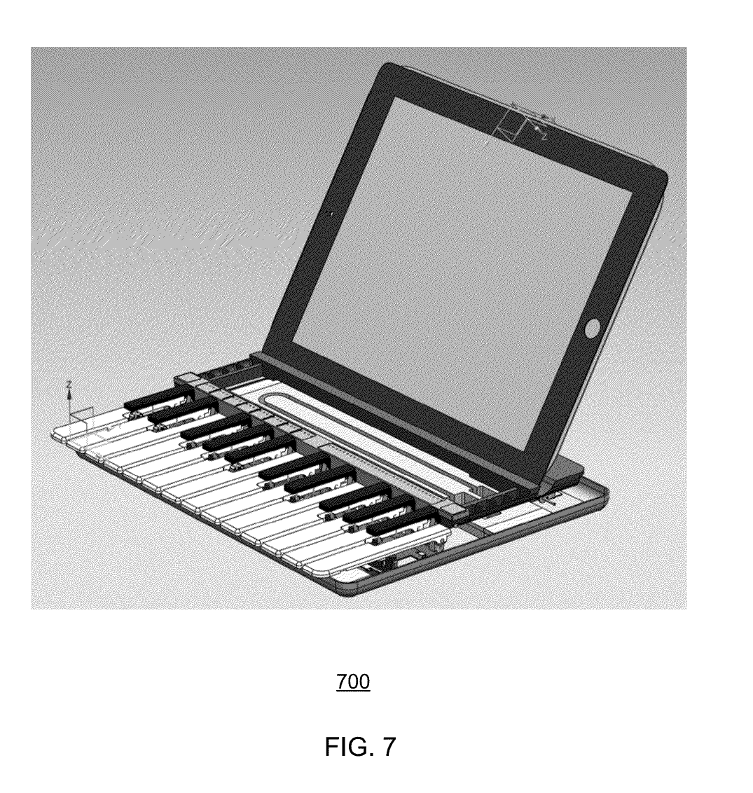

FIG. 7 is a schematic perspective view of an example pop-up assembly 700 implemented as a keyboard apparatus in an open state, according to some embodiments. Keyboard apparatus 700 includes a rack, which is supported by a four-bar mechanism such as four-bar mechanism 104 of FIG. 1. The rack is configured to hold a user interface device (e.g., a display device, a computing device such as a tablet computer, etc.).

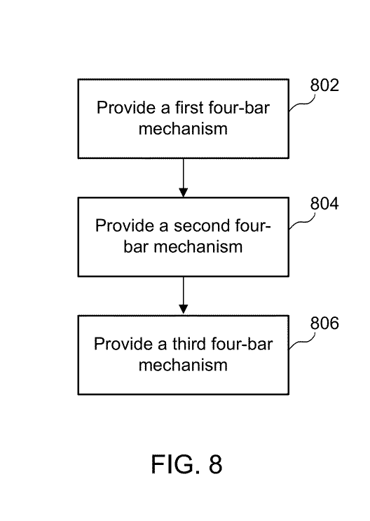

FIG. 8 illustrates an example simplified flow diagram for providing a pop-up apparatus, according to some embodiments. Referring to both FIGS. 1 and 8, in various implementations, a method is initiated in block 802 where a first four-bar mechanism 102 is provided. In various embodiments, four-bar mechanism 102 is a four-bar parallelogram linkage. In various embodiments, four-bar mechanism 102 is operably connected to a first user interface, where four-bar mechanism 102 enables the first user interface to be positioned in a first plane.

In block 804, a second four-bar mechanism 104 is provided. In various embodiments, four-bar mechanism 104 is a four-bar parallelogram linkage. In various embodiments, four-bar mechanism 104 is operably connected to a second user interface, where four-bar mechanism 104 enables the second user interface to be positioned in a second plane.

In block 806, a third four-bar mechanism 104 is provided. In various embodiments, four-bar mechanism 106 is a convex quadrilateral linkage. In various embodiments, four-bar mechanism 106 is operably connected to the first and second four-bar mechanisms 102 and 106, where four-bar mechanism 106 synchronizes movement of the first and second four-bar mechanisms 102 and 106.

Embodiments described herein provide various benefits. For example, embodiments enable a user to enjoy a music playing experience that is relatively close to that of playing a standard size musical instrument. Embodiments provide a music device that is not only of reduced size while in a playable configuration, but also readily reconfigurable into an extremely compact, “collapsed” form when being transported or stored. Embodiments enable professional and non-professional musicians to enjoy a playing experience similar in many important respects to that of playing a standard piano keyboard, while avoiding the inconvenience of larger size and greater weight inherent in such an instrument. These benefits may be especially valuable to the mobile user.

Although the description has been described with respect to particular embodiments thereof, these particular embodiments are merely illustrative, and not restrictive. Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments. For example, a tangible medium such as a hardware storage device can be used to store the control logic, which can include executable instructions.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. An apparatus comprising:
a first four-bar mechanism operably connected to a first user interface;
a second four-bar mechanism operably connected to a second user interface; and
a third four-bar mechanism operably connected to the first and second four-bar mechanisms.

2. The apparatus of claim 1, wherein the third four-bar mechanism synchronizes movement of the first and second four-bar mechanisms.

3. The apparatus of claim 1, wherein at least two of the four-bar-mechanisms are four-bar parallelogram linkages.

4. The apparatus of claim 1, wherein at least one of the four-bar-mechanisms is a four-bar convex quadrilateral linkage.

5. The apparatus of claim 1, further comprising a base that functions as a support base for the apparatus.

6. The apparatus of claim 1, further comprising a base that functions as a common bar in each of the first mechanism, the second mechanism, and the third four-bar mechanism.

7. The apparatus of claim 1, wherein the first four-bar mechanism enables the first user interface to be positioned in a first plane.

8. The apparatus of claim 1, wherein the second four-bar mechanism enables the second user interface to be positioned in a second plane.

9. The apparatus of claim 1, wherein the first four-bar mechanism enables the first user interface to be positioned in a first plane, wherein the second four-bar mechanism enables the second user interface to be positioned in a second plane, and wherein the first plane is different from the second plane.

10. An apparatus comprising:
a first four-bar mechanism operably connected to a first user interface, wherein the first four-bar mechanism enables the first user interface to be positioned in a first plane;
a second four-bar mechanism operably connected to a second user interface, wherein the second four-bar mechanism enables the second user interface to be positioned in a second plane; and
a third four-bar mechanism operably connected to the first and second four-bar mechanisms.

11. The apparatus of claim 10, wherein the third four-bar mechanism synchronizes movement of the first and second four-bar mechanisms.

12. The apparatus of claim 10, wherein at least two of the four-bar-mechanisms are four-bar parallelogram linkages.

13. The apparatus of claim 10, wherein at least one of the four-bar-mechanisms is a four-bar convex quadrilateral linkage.

14. The apparatus of claim 10, further comprising a base that functions as a support base for the apparatus.

15. A method comprising:
providing a first four-bar mechanism operably connected to a first user interface;
providing a second four-bar mechanism operably connected to a second user interface; and
providing a third four-bar mechanism operably connected to the first and second four-bar mechanisms.

16. The method of claim 15, wherein the first four-bar mechanism enables the first user interface to be positioned in a first plane

17. The method of claim 15, wherein the second four-bar mechanism enables the second user interface to be positioned in a second plane

18. The method of claim 15, wherein the third four-bar mechanism synchronizes movement of the first and second four-bar mechanisms.

19. The method of claim 15, wherein at least two of the four-bar-mechanisms are four-bar parallelogram linkages.

20. The method of claim 15, wherein at least one of the four-bar-mechanisms is a four-bar convex quadrilateral linkage.
